(19) United States
(12) Patent Application Publication
(10) Pub. No.: US 2024/0293750 A1
(43) Pub. Date: Sep. 5, 2024

(54) NON-TRANSITORY COMPUTER READABLE MEDIUM, INFORMATION PROCESSING METHOD, AND INFORMATION PROCESSING SYSTEM

(71) Applicant: CYGAMES, INC., Tokyo (JP)

(72) Inventors: Ryohei Ishizuka, Tokyo (JP); Shinichiro Hirano, Tokyo (JP); Reiji Suzumaru, Tokyo (JP); Hiroki Tsuda, Tokyo (JP); Eri Tatsuzawa, Tokyo (JP); Yuji Okada, Tokyo (JP); Asahi Inoue, Tokyo (JP)

(73) Assignee: CYGAMES, INC., Tokyo (JP)

(21) Appl. No.: 18/647,882

(22) Filed: Apr. 26, 2024

Related U.S. Application Data
(63) Continuation of application No. PCT/JP2022/040766, filed on Oct. 31, 2022.

(30) Foreign Application Priority Data
Oct. 29, 2021 (JP) 2021-177027

(51) Int. Cl. A63F 13/69

(52) U.S. Cl. CPC A63F 13/69

(57) ABSTRACT

A non-transitory computer readable medium stores a program causing a computer to execute: determining a reward based on a reached game stage when a game is started in a first mode in which game stages proceed based on an operation input by a player while a game screen is displayed; and determining a reward based on an elapsed time or a reached game stage when the game is started in a second mode in which the player operation input and the game screen display are not required and the game stages proceed in association with the passage of time. The types of the rewards determined in the first and second modes are the same. In the second mode, the amount of time required to reach a first game stage is greater than the shortest time by which the first game stage can be reached in the first mode.

### CROSS REFERENCE TO RELATED APPLICATIONS

This application is a continuation application of International Application No. PCT/JP2022/040766, filed on Oct. 31, 2022, which claims priority to Japanese Patent Application No. 2021-177027, filed on Oct. 29, 2021, the entire contents of which are incorporated by reference herein.

### BACKGROUND ART

### Technical Field

The present invention relates to an information processing program, an information processing method, and an information processing system.

In the related art, there is a known game in which a plurality of game fields are provided and a different game field is selected each time the game is played, as indicated in Patent Literature 1. Although a player needs to repeatedly play the game in order to obtain desired items, experience points, etc., it is possible to enhance the play motivation as a result of the game field being different each time the game is played.

### CITATION LIST

### Patent Literature

Patent Literature 1: JP 6464618 B

### SUMMARY OF INVENTION

### Technical Problem

As indicated above, a large amount of time is necessary to repeat the game many times and there is risk of many players giving up to obtain desired items, etc. To cope with this risk, there is a known game in which a skip function or the like is implemented, which makes it possible to obtain items, etc. in the same manner as when the game is played, while omitting the game play.

However, there is a problem in that, implementing a function that makes it possible to omit the game play reduces player motivation to actually play a game, and thus, the original amusement of the game is reduced.

It is an object of the present invention to provide an information processing program, an information processing method, and an information processing system with which it is possible to suppress a reduction of the play motivation of a player.

### Solution to Problem

In order to solve the above-described problem, provided is an information processing program that causes a computer to execute: processing for determining a reward on the basis of a reached game stage when a game is started in a first play mode in which game stages proceed on the basis of an operation input by a player while a game screen is displayed; processing for determining a reward on the basis of an elapsed time or a reached game stage when the game is started in a second play mode in which the player operation input and the game screen display are not required and the game stages proceed in association with the passage of time; and processing for giving the determined reward to the player, wherein the type of the reward determined in the second play mode is the same as the type of the reward determined in the first play mode and, in the second play mode, the amount of time required to reach a first game stage is greater than the amount of time by which the first game stage can be reached in the first play mode.

In addition, the information processing program may cause a computer to further execute: processing for advancing the game on the basis of the operation input by the player in the case in which the game is started in the first play mode; and processing for receiving a skip operation input by the player in the first play mode, wherein, in the case in which the skip operation is received in the first play mode, the processing for advancing the game on the basis of the operation input by the player skips one or more game stages and the game is started from a second game stage.

In addition, the information processing program may cause a computer to further execute: processing for receiving the skip operation input by the player in the second play mode, wherein, in the case in which the skip operation is received in the second play mode, the amount of time required to reach a prescribed game stage is reduced.

In order to solve the above-described problem, also provided is an information processing method executed by a computer, the information processing method including: processing for determining a reward on the basis of a reached game stage when a game is started in a first play mode in which game stages proceed on the basis of an operation input by a player while a game screen is displayed; processing for determining a reward on the basis of an elapsed time or a reached game stage when the game is started in a second play mode in which the player operation input and the game screen display are not required and the game stages proceed in association with the passage of time; and processing for giving the determined reward to the player, wherein the type of the reward determined in the first play mode is the same as the type of the reward determined in the second play mode and, in the second play mode, the amount of time required to reach a first game stage is greater than the shortest time by which the first game stage can be reached in the first play mode.

In order to solve the above-described problem, also provided is an information processing system in which a computer executes: processing for determining a reward on the basis of a reached game stage when a game is started in a first play mode in which game stages proceed on the basis of an operation input by a player while a game screen is displayed; processing for determining a reward on the basis of an elapsed time or a reached game stage when the game is started in a second play mode in which the player operation input and the game screen display are not required and the game stages proceed in association with the passage of time; and processing for giving the determined reward to the player, wherein the type of the reward determined in the first play mode is the same as the type of the reward determined in the second play mode and, in the second play mode, the amount of time required to reach a first game stage is greater than the shortest time by which the first game stage can be reached in the first play mode.

### Effects of Disclosure

With the present invention, it is possible to enhance the play motivation of a player.

### BRIEF DESCRIPTION OF DRAWINGS

FIG. 1 is an explanatory diagram showing, in outline, a configuration of an information processing system.

FIG. 2A is a diagram for explaining the hardware configuration of player terminal hardware.

FIG. 2B is a diagram for explaining the hardware configuration of a server.

FIG. 3A is a diagram for explaining an example of a dungeon quest top screen.

FIG. 3B is a diagram for explaining an example of a character selection screen.

FIG. 3C is a diagram for explaining an example of a skill selection screen.

FIG. 4A is a first diagram for explaining an example of a game screen.

FIG. 4B is a diagram for explaining an example of a stage clear screen.

FIG. 4C is a second diagram for explaining an example of the game screen.

FIG. 4D is a diagram for explaining an example of a result screen.

FIG. 5 is a diagram for explaining the relationship between floors and stages.

FIG. 6A is a diagram for explaining an example of a number-of-floors-to-be-skipped selection screen.

FIG. 6B is a diagram for explaining an example of a case in which a number-of-floors-to-be-skipped selection operation portion is operated.

FIG. 6C is a diagram for explaining an example of a skip reward screen.

FIG. 6D is a diagram for explaining an example of the game screen in the case in which a skip function is used.

FIG. 7 is a diagram for explaining the relationship between the highest floor reached and the number of floors that can be skipped.

FIG. 8A is a diagram for explaining an example of an auto-play-mode setting screen.

FIG. 8B is a diagram for explaining an example of a top screen when a dungeon quest is being played in an auto play mode.

FIG. 8C is a diagram for explaining an example of an interruption dialog 52.

FIG. 8D is a diagram for explaining an example of an auto-play-mode result screen.

FIG. 9A is a diagram for explaining an example of a number-of-floors-to-be-skipped selection screen for the auto play mode.

FIG. 9B is a diagram for explaining remaining time when the skip function is used in the auto play mode.

FIG. 10 is a diagram for explaining examples of normal reward tables.

FIG. 11 is a diagram for explaining examples of skip reward tables.

FIG. 12 is a diagram for explaining examples of auto reward tables.

FIG. 13 is a diagram for explaining an example of the breakdown of rewards for each table classification.

FIG. 14 is a diagram for explaining a memory configuration of the player terminal and functions as a computer.

FIG. 15 is a diagram for explaining a memory configuration of the server and functions as a computer.

FIG. 16 is a sequence diagram for explaining basic processing performed in the player terminal and the server.

FIG. 17 is a flowchart for explaining preparation processing performed in the player terminal.

FIG. 18 is a flowchart for explaining skip setting processing performed in the player terminal.

FIG. 19 is a flowchart for explaining start processing performed in the server.

FIG. 20 is a flowchart for explaining reward lottery processing performed in the server.

FIG. 21 is a flowchart for explaining normal-play execution processing performed in the player terminal.

FIG. 22 is a flowchart for explaining auto-play ending processing performed in the server.

### DESCRIPTION OF EMBODIMENT

An aspect of an embodiment of the present invention will be described below with reference to the drawings. Values, etc. indicated in said embodiment are merely examples for facilitating understanding, and do not limit the present invention unless otherwise specifically mentioned. Note that, in the present description and the drawings, elements having substantially the same functions and configurations have the same reference signs attached thereto and are not described repeatedly, and, in addition, elements that are not directly relevant to the present invention are not shown.

### (Overall Configuration of Information Processing System S)

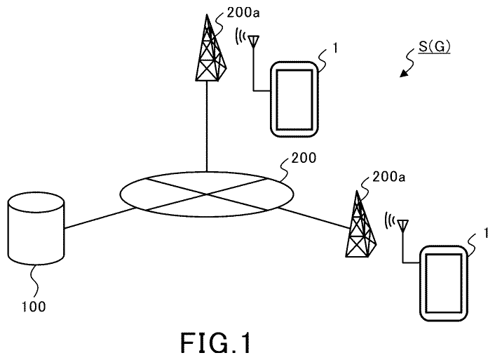

FIG. 1 is an explanatory diagram showing, in outline, the configuration of an information processing system S. The information processing system S is a so-called client-server system including player terminals 1 (game terminals), a server 100, and a communication network 200 having communication base stations 200a.

In the information processing system S of this embodiment, the player terminals 1 and the server 100 serve as a game device G. Functions in game proceeding control are respectively allocated to the player terminals 1 and the server 100 and a game can proceed as a result of cooperation between the player terminals 1 and the server 100.

The player terminals 1 can establish communication with the server 100 via the communication network 200. The player terminals 1 include a wide range of electronic appliances that are capable of communicatively connecting to the server 100 in a wireless or wired manner. Examples of the player terminals 1 include smartphones, mobile phones, tablet devices, personal computers, and game machines. This embodiment will be described in the context of a case where smartphones are used as the player terminals 1.

The server 100 is communicatively connected to the plurality of player terminals 1. The server 100 accumulates various kinds of information (hereinafter referred to as the player information) for each piece of player identification information (hereinafter referred to as the player ID) for identifying a player who plays the game. In addition, the server 100 updates the accumulated information on the basis of operations input from the player terminals 1.

The communication base stations 200a are connected to the communication network 200 and transmit information to and receive information from the player terminals 1 in a wireless manner. The communication network 200 consists of a mobile phone network, an internet network, a local area network (LAN), a dedicated line, or the like and realizes wireless or wired communication connection between the player terminals 1 and the server 100.

### (Hardware Configurations of Player Terminal 1 and Server 100)

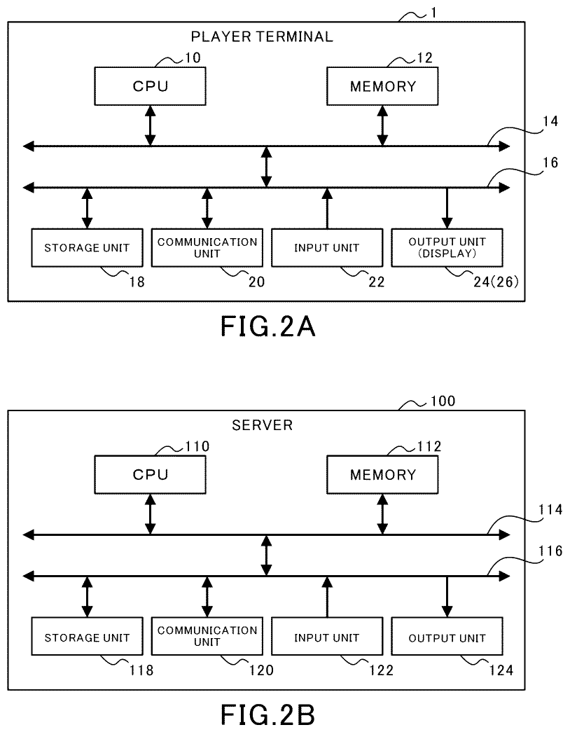

FIG. 2A is a diagram for explaining the hardware configuration of a player terminal 1. In addition, FIG. 2B is a diagram for explaining the hardware configuration of the server 100. As shown in FIG. 2A, the player terminal 1 is configured to include a central processing unit (CPU) 10, a memory 12, a bus 14, an input/output interface 16, a storage unit 18, a communication unit 20, an input unit 22, and an output unit 24.

In addition, as shown in FIG. 2B, the server 100 is configured to include a CPU 110, a memory 112, a bus 114, an input/output interface 116, a storage unit 118, a communication unit 120, an input unit 122, and an output unit 124. Note that the configurations and functions of the CPU 110, the memory 112, the bus 114, the input/output interface 116, the storage unit 118, the communication unit 120, the input unit 122, and the output unit 124 of the server 100 are substantially the same as those of the CPU 10, the memory 12, the bus 14, the input/output interface 16, the storage unit 18, the communication unit 20, the input unit 22, and the output unit 24 of the player terminal 1, respectively. Therefore, the following description will be directed to the hardware configuration of the player terminal 1, while omitting a description of the server 100.

The CPU 10 runs a program stored in the memory 12 to control the proceeding of the game. The memory 12 is configured of a read only memory (ROM) or a random access memory (RAN) and stores the program and various kinds of data needed to control the proceeding of the game. The memory 12 is connected to the CPU 10 via the bus 14.

The input/output interface 16 is connected to the bus 14. The storage unit 18, the communication unit 20, the input unit 22, and the output unit 24 are connected to the input/output interface 16.

The storage unit 18 is configured of a semiconductor memory such as a dynamic random access memory (DRAM) and stores various kinds of programs and data. In the player terminal 1, the programs and data stored in the storage unit 18 are loaded into the memory 12 (RA) by the CPU 10.

The communication unit 20 is communicatively connected to a communication base station 200a in a wireless manner and transmits information to and receives information from the server 100, such as various kinds of data and programs, via the communication network 200. In the player terminal 1, programs, etc. received from the server 100 are stored in the memory 12 or the storage unit 18.

The input unit 22 is configured of a unit via which player operations are input (operations are accepted), for example, a touchscreen, buttons, a keyboard, a mouse, a cross keypad, an analog controller, or the like. In addition, the input unit 22 may be a dedicated controller that is provided in the player terminal 1 or connected (externally) to the player terminal 1. Furthermore, the input unit 22 may be configured of an acceleration sensor that detects tilting or movement of the player terminal 1 or a microphone that detects the player's voice. In other words, the input unit 22 includes a wide range of devices that enable the input of the player's intents in distinguishable manners.

The output unit 24 is configured to include a display device and a speaker. Note that the output unit 24 may be a device connected (externally) to the player terminal 1. In this embodiment, the player terminal 1 includes a display 26 as the output unit 24 and a touchscreen as the input unit 22, the touchscreen being provided so as to be overlaid on the display 26.

### (Game Specifics)

Next, the specifics of the game provided by the information processing system S (game device G) in this embodiment will be described by using an example. A player can own characters obtained by a lottery, a so-called gacha, and characters distributed from the administration side. The player can play a quest by employing characters the player owns (hereinafter referred to as the owned characters).

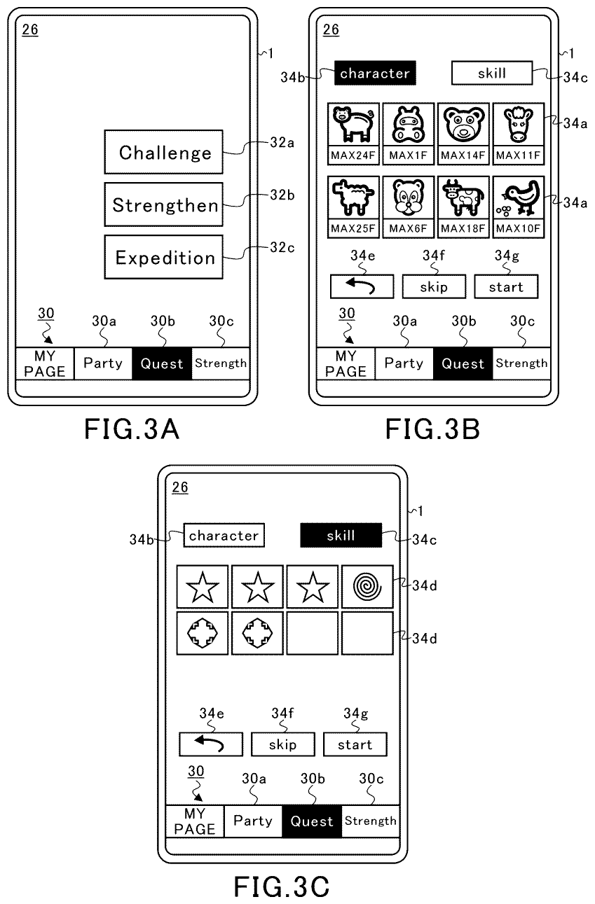

FIG. 3A is a diagram for explaining an example of a top screen of a dungeon quest. During a game, a menu bar 30 is displayed in a bottom section of the display 26. The menu bar 30 is provided with a plurality of selection portions including a party-formation selection portion 30a, a quest selection portion 30b, and an enhancement selection portion 30c.

When the party-formation selection portion 30a is tapped, a party formation screen (not shown) is displayed. The player can form a party by selecting four owned characters on the party formation screen. In addition, although a detailed description will be omitted, it is possible to equip the owned characters included in the party with equipment such as weapons on the party formation screen.

When the enhancement selection portion 30c is tapped, an enhancement screen (not shown) is displayed. The player can enhance the owned characters and equipment on the enhancement screen.

In addition, when the quest selection portion 30b is tapped, a quest selection screen (not shown) is displayed. Multiple types of quests are displayed on the quest selection screen. The game device G in this embodiment provides an action role-playing game (RPG) as the quests. In each quest, the player can move the characters placed in a virtual game space captured by a virtual camera and make the characters perform offensive motions. Each quest is cleared when all enemy characters are eliminated or a clear condition such as defeating a prescribed boss character is satisfied. Here, multiple types of quests with different virtual game spaces and difficulty levels are provided.

In addition, the quests include: quests that can be played only in a single player mode in which the player takes on a challenge alone; quests that can be played only in a multiplayer mode in which a plurality of players take on a challenge; and quests in which the single player mode or the multiplayer mode can be selected.

In addition, the quests can be roughly classified into normal quests that are played by employing a party consisting of four owned characters and special quests that are played by employing only one owned character. In the normal quests, the owned characters and equipment enhanced in the above-described enhancement screen can be employed. In contrast, in the special quests, an owned character that is dedicated to the special quests can be enhanced, and parameters of the owned characters for the normal quests cannot be carried over to the special quests. In addition, it is also not possible to use the equipment enhanced for the normal quests in the special quests.

In other words, the normal quests and the special quests are completely different types of games. However, in this embodiment, it is possible to obtain special items in the special quests. The special items can be used in the normal quests or used to enhance the equipment for the normal quests. Accordingly, by allowing the special items obtained in the special quests to be used in the normal quests, the relationship between the normal quests and the special quests is increased and play motivation for both types of quests is enhanced.

In this embodiment, a dungeon quest is provided as a special quest. The dungeon quest starts from a stage on a first floor, and the floor number is incremented by one every time a stage is cleared. Then, the dungeon quest is completely cleared when finally a stage of a 50^{th} floor is cleared. Note that, in the dungeon quest, stages corresponding to the floor numbers that are multiples of five are set to be boss stages and stages corresponding to other floor numbers are set to be normal stages.

In a normal stage, a labyrinth is set as a virtual game space. In this labyrinth, a start point and a goal point are set and, when a game is started, one character (hereinafter referred to as the subject character) selected by the player is placed at the start point. Then, the normal stage is cleared when the subject character controlled by the player reaches the goal point and the player can go up one floor.

Note that, in the normal stage, small-fry characters, which are enemy characters, are placed and the player must advance through the labyrinth while defeating the small-fry characters. The subject character has a set HP and the HP decreases due to attacks received from the enemy characters. Also, if the HP of the subject character reaches 0, the game is over.

Here, reaching the goal point is not necessarily the clear condition of the normal stage. For example, defeating all small-fry characters placed in the labyrinth may be set as the clear condition. In this case, the clear condition may be different for each normal stage or the clear condition may be the same for all normal stages.

In addition, in a boss stage, one or a plurality of boss characters, which are enemy characters, are placed, the boss stage is cleared by defeating all boss characters placed in the stage, and the player can go up one floor. In both normal stages and boss stages, stronger enemy characters are placed as the floor number increases and the difficulty level increases as the floor number increases. In the dungeon quest, rewards are given to the player in accordance with the reached floor. Rewards with greater rarity are given as the reached floor increases.

When the dungeon quest is selected on the quest selection screen (not shown), a dungeon quest top screen shown in FIG. 3A is displayed. On the dungeon quest top screen, a normal-play-mode selection operation portion 32a, an enhancement operation portion 32b, and an auto-play-mode selection operation portion 32c are provided.

In the dungeon quest, two play modes, namely, a normal play mode (first play mode) and an auto play mode (second play mode), are provided. The normal play mode is a play mode in which game stages advance on the basis of player operations input while a game screen is displayed. The auto play mode is a play mode that does not require the player operation inputs and the game screen display and in which the game stages advance in association with passage of time.

The normal-play-mode selection operation portion 32a corresponds to the normal play mode and the auto-play-mode selection operation portion 32c corresponds to the auto play mode. By tapping the normal-play-mode selection operation portion 32a or the auto-play-mode selection operation portion 32c, the player can select the play mode. When the normal-play-mode selection operation portion 32a is tapped, a character selection screen is displayed and the normal play mode is set in a preparation state.

FIG. 3B is a diagram for explaining an example of the character selection screen. On the character selection screen, a plurality of character icons 34a corresponding to the owned characters are displayed. A character icon 34a displays an image with which a character can be identified and the highest floor that the corresponding character has reached in the dungeon quest. By tapping the character icon 34a on the character selection screen, the player can select the subject character.

In addition, on the character selection screen, a character tab 34b and a skill tab 34c are provided above the character icons 34a. Note that the character tab 34b is displayed in an emphasized manner while the character selection screen is displayed. When the skill tab 34c is tapped on the character selection screen, a skill selection screen is displayed.

FIG. 3C is a diagram for explaining an example of the skill selection screen. The skill tab 34c is displayed in an emphasized manner while the skill selection screen is displayed. On the skill selection screen, a plurality of skill icons 34d are displayed. A skill icon 34d displays an image with which a skill can be identified. By tapping the skill icon 34d on the skill selection screen, the player can select the skill.

Here, a skill is a special ability activated by the subject character. As the skills, for example, offensive skills that are capable of inflicting greater damage on the enemy characters than a normal attack, defensive skills that increase the defensive strength of the subject character, recovery skills that restore the HP of the subject character, etc. are provided. By tapping the skill icons 34d on the skill selection screen, the player can select the skills to be used in the dungeon quest. Here, the player can set a plurality of skills that can be used in the dungeon quest.

When the character tab 34b is tapped on the skill selection screen, the character selection screen is displayed on the display 26. In addition, on the character selection screen and the skill selection screen, a return operation portion 34e, a skip operation portion 34f, and a start operation portion 34g are provided. When the return operation portion 34e is tapped, the top screen shown in FIG. 3A is displayed on the display 26. When the skip operation portion 34f is tapped, a number-of-floors-to-be-skipped selection screen, described later, is displayed. When the start operation portion 34g is tapped, the dungeon quest in the normal play mode employing the subject characters and the skills selected by the player is started.

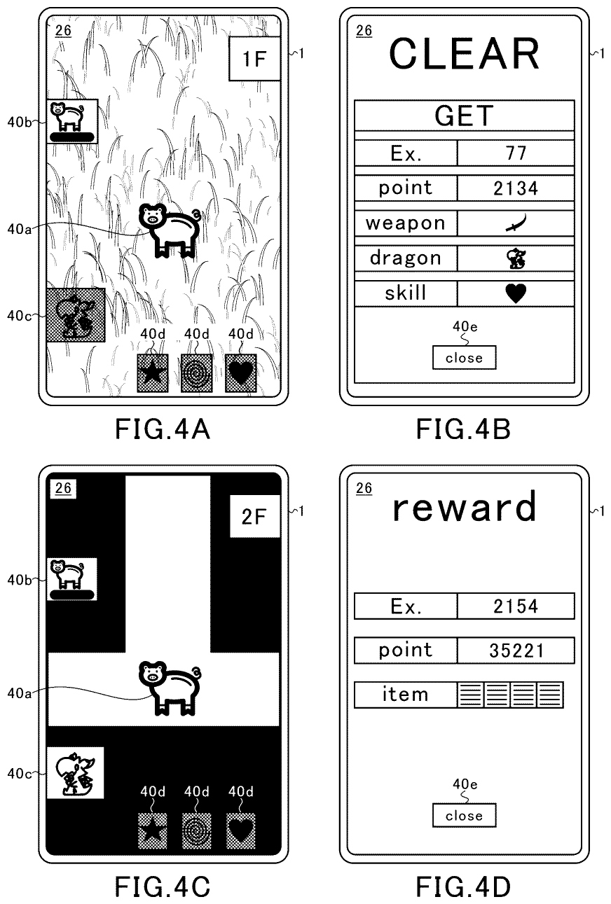

FIG. 4A is a first diagram for explaining an example of the game screen. FIG. 4B is a diagram for explaining an example of a stage clear screen. FIG. 4C is a second diagram for explaining an example of the game screen. FIG. 4D is a diagram for explaining an example of a result screen. When the dungeon quest in the normal play mode is started, the virtual game space corresponding to the stage on the 1^{st} floor is displayed on the display 26. At a center of the virtual game space, a subject character image 40a is displayed.

By inputting direction instructing operations via the touchscreen, the player can move the subject character image 40a in desired directions. In a direction instructing operation, a state in which the touchscreen is touched is maintained for a prescribed amount of time or longer. For example, when the touched position is slid upward in the state in which the touchscreen is touched, the subject character image 40a moves upward in the virtual game space. Note that the subject character image 40a is basically displayed near the center of the display 26; therefore, in this case, the screen is updated so that the virtual game space is moved toward the bottom from the top.

In addition, by inputting offensive operations via the touchscreen, the player can cause the subject character image 40a to perform offensive motions. An offensive operation is, for example, a tap operation of the touchscreen. When the subject character image 40a performs offensive motions, it is possible to inflict damage on the enemy characters in the surrounding area.

In addition, on the game screen, a subject-character-information display portion 40b, a dragon display portion 40c, and three skill operation portions 40d are displayed. The subject-character-information display portion 40b displays the subject character icon and the HP of the subject character. The dragon display portion 40c displays a dragon icon. Although a detailed description will be omitted, the player can obtain dragons while playing the dungeon quest. The player can transform into an obtained dragon only for a prescribed amount of time. In other words, the player can change the subject character to an obtained dragon only for a prescribed amount of time.

Among other features, a dragon inflicts greater damage on the enemy characters as compared with the normal subject character and, in addition, the HP of the subject character does not decrease while being transformed into the dragon, and thus, by transforming into the dragon, the player can advance through the dungeon quest in an advantageous manner. By tapping the dragon display portion 40c, the player can change the subject character into the dragon.

Note that conditions for transforming into the dragon are set in advance, and, as shown in FIG. 4A, the dragon display portion 40c is grayed out in a state in which the conditions are not satisfied. In this state, the dragon display portion 40c does not accept an operation, and thus, it is not possible to transform into the dragon.

The skill operation portions 40d display icons corresponding to the skills that the player possesses. The player can activate the skills by tapping the skill operation portions 40d. Note that the player can acquire skills while playing the dungeon quest. Therefore, the player can also use the skills acquired while playing the dungeon quest in addition to the skills set before starting the dungeon quest.

Note that skill activation conditions are set in advance and, as shown in FIG. 4A, the skill operation portions 40d are grayed out in a state in which the conditions are not satisfied. In this state, the skill operation portions 40d do not accept operations and it is not possible to activate the skills.

Then, when the stage is cleared, a stage clear screen shown in FIG. 4B is displayed. In the normal play mode, rewards are given to the player each time a stage is cleared. In the following, the rewards given to the player each time a stage is cleared will be referred to as the stage rewards. The stage rewards are set for each stage and, when a stage is cleared, the stage rewards to be given to the player are determined by means of lotteries.

The stage rewards include experience points, points, weapons, dragons, and skills. The experience points are given to the subject character. When the experience points obtained as the stage rewards reach a prescribed value, the level of the subject character increases. When the level of the subject character increases, parameters of the subject character, such as the offensive strength, increase.

The points obtained as the stage rewards can be used to enhance the owned characters. Specifically, when the enhancement operation portion 32b is tapped on the top screen shown in FIG. 3A, a character enhancement screen dedicated to the dungeon quest is displayed. On this character enhancement screen, it is possible to increase the parameters of the owned characters in the dungeon quest by using the points.

The weapons, the dragons, and the skills obtained as the stage reward can be used in the dungeon quest that is being played. Note that the weapons, the dragons, and the skills obtained as the stage rewards can be used only in the dungeon quest that is currently being played and the data are deleted when the dungeon quest that is being played is ended. In other words, the weapons, the dragons, and the skills obtained as the stage rewards cannot be carried over to the next and later dungeon quests. In contrast, the experience points and the points obtained as the stage rewards are accumulated when the dungeon quest that is being played ends.

When a close operation portion 40e provided on the stage clear screen is tapped, the stage clear screen becomes hidden. Then, as shown in FIG. 4C, the virtual game space of the stage of next floor is displayed and the dungeon quest is restarted. Here, in this embodiment, in the case in which the dungeon quest is played in the normal play mode, the stages of the individual floors are determined as indicated below.

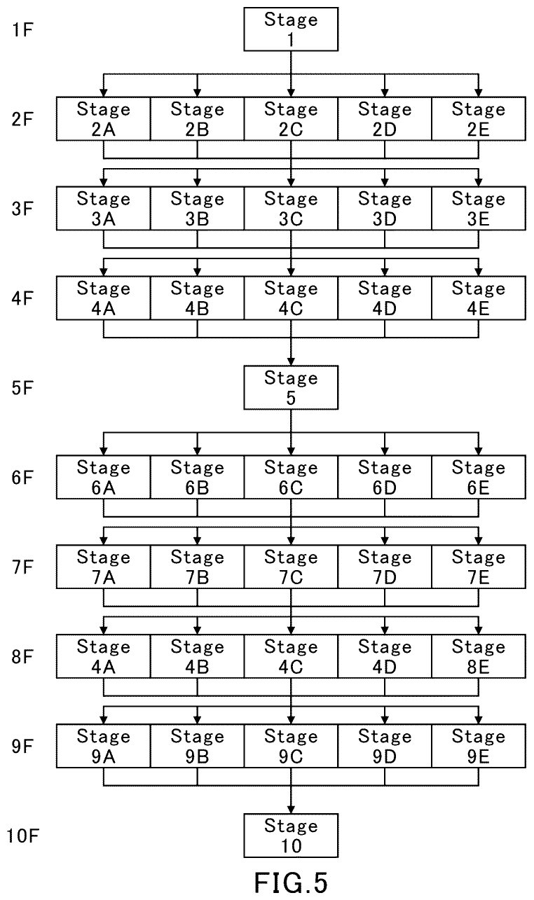

FIG. 5 is a diagram for explaining the relationship between the floors and the stages. Because the 1^{st} floor is provided with only one type of normal stage, namely, a stage 1, the dungeon quest always starts from stage 1. When stage 1 is cleared, a stage on the 2^{nd} floor is started next. The 2^{nd} floor is provided with five types of normal stages, namely, stages 2A, 2B, 2C, 2D, and 2E, and one of the five types of the normal stages is determined by means of a lottery.

As indicated above, the floors in which the floor numbers are other than multiples of five are set to be the normal stages. Each of the normal stages, excluding the 1^{st} floor, is provided with five types of normal stages, and the stage to be played by the player is determined from the five types of normal stages. The five types of normal stages corresponding to the same floor have slightly different difficulty levels.

On the other hand, each of the floors that are set to be the boss stages is provided with only one boss stage. Therefore, the player always plays the same boss stages on the floors in which the floor numbers are multiples of five. Note that each of the floors that are set to be the boss stages may also be provided with a plurality of boss stages having different difficulty levels, as with the floors that are set to be the normal stages.

As has been described above, because the stages to be cleared are randomly determined, routes are different each time the dungeon quest is played, and thus, any dullness the player may feel is reduced. Then, when the dungeon quest is completely cleared by clearing the stage on the top floor or when the game is over, the result screen shown in FIG. 4D is displayed.

On the result screen, a list of rewards to be given to the player is displayed. On the result screen, the experience points, the points, and the items obtained while playing the dungeon quest are displayed. Note that, as described above, the weapons, the dragons, and the skills obtained while playing the dungeon quest cannot be carried over to the next and later dungeon quests. Therefore, the weapons, the dragons, and the skills obtained as the stage rewards while playing the dungeon quest are not displayed on the result screen.

In contrast, the stage rewards include the special items that can be used in games other than the dungeon quest, such as the normal quests, and thus, the special item obtained while playing the dungeon quest is displayed on the result screen. When the close operation portion 40e provided on the result screen is tapped, the top screen shown in FIG. 3A is displayed and the dungeon quest in the normal play mode is ended.

Here, the dungeon quest is provided with a skip function. When the player uses the skip function in the normal play mode, a dungeon quest can be played from a prescribed floor by skipping the number of floors selected by the player. When the skip operation portion 34f is tapped in a state in which a subject character or a skill is selected on the character selection screen shown in FIG. 3B or the skill selection screen shown in FIG. 3C, the number-of-floors-to-be-skipped selection screen is displayed.

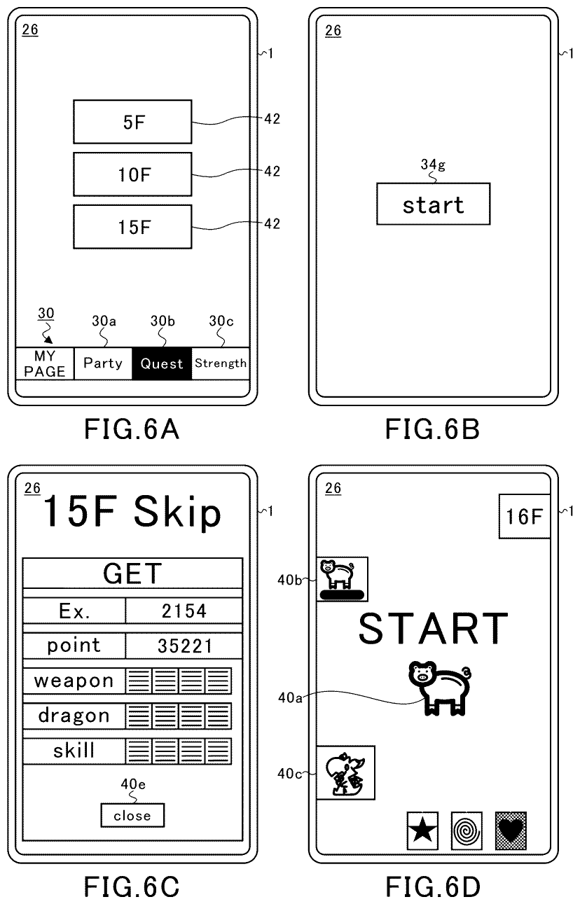

FIG. 6A is a diagram for explaining an example of the number-of-floors-to-be-skipped selection screen. FIG. 6B is a diagram for explaining an example of a case in which a number-of-floors-to-be-skipped selection operation portion is operated. FIG. 6C is a diagram for explaining an example of a skip reward screen. FIG. 6D is a diagram for explaining an example of the game screen of a case in which the skip function is used. As shown in FIG. 6A, the number-of-floors-to-be-skipped selection screen displays a number-of-floors-to-be-skipped selection operation portion 42. The number-of-floors-to-be-skipped selection operation portion 42 displays the number of floors that can be skipped. In the example shown in FIG. 6A, three number-of-floors-to-be-skipped selection operation portions 42 that respectively indicate 5F, 10F, and 15F are displayed. The number of floors that can be skipped are set every five floors, and the player can set the number of floors to be skipped within the range defined by the highest floor reached by the selected subject character.

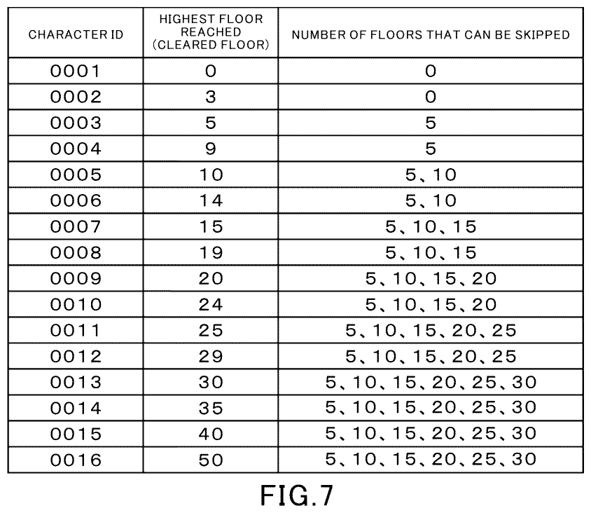

FIG. 7 is a diagram for explaining the relationship between the highest floor reached and the number of floors that can be skipped. As shown in FIG. 7, character IDs are associated with characters that the player can own. In addition, when the player plays a dungeon quest by selecting a subject character from the owned characters, of the floors reached by said subject character, a highest floor reached, in other words, a highest cleared floor is stored as the highest floor reached.

The player can set the number of floors to be skipped every five floors within the range defined by the highest floor reached by an owned character selected as the subject character. For example, the highest floors reached by the owned characters having character IDs of “0001” and “0002” are 0 and 3, respectively. Therefore, the number of floors that can be skipped is 0 in the case in which either one of these owned characters is selected as the subject character. In other words, the player cannot use the skip function in the case in which one of the owned characters having the character IDs of “0001” and “0002” is selected.

In addition, for example, the highest floors reached by the owned characters having character IDs of “0003” and “0004” are 5 and 9, respectively. Therefore, the number of floors that can be skipped is 5 in the case in which either one of these owned characters is selected as the subject character. In addition, for example, the highest floors reached by the owned characters having character IDs of “0005” and “0006” are 10 and 14, respectively. Therefore, the player can select one of 5 and 10 as the number of floors that can be skipped in the case in which either one of these owned characters is selected as the subject character.

Note that, here, an upper limit of the number of floors that can be skipped is set to be 30. Therefore, the number of floors that can be skipped by the owned characters having highest floors reached of 30 or greater is 5, 10, 15, 20, 25, and 30 in all cases.

However, the above-described number of floors that can be skipped are merely examples. For example, the upper limit of the number of floors that can be skipped is not essential. In addition, the number of floors that can be skipped may be set so as to make it possible to skip as many floors as the highest floor reached, instead of every five floors. Furthermore, instead of setting the number of floors that can be skipped for each owned character, the number of floors that can be skipped may be set on the basis of the highest floor reached by the player.

As shown in FIG. 6A, the number-of-floors-to-be-skipped selection screen displays the number-of-floors-to-be-skipped selection operation portions 42 corresponding to the number of floors the player can skip. When a number-of-floors-to-be-skipped selection operation portion 42 is tapped, as shown in FIG. 6B, the start operation portion 34g is displayed on the number-of-floors-to-be-skipped selection screen and, when the start operation portion 34g is tapped, the skip reward screen shown in FIG. 6C is displayed.

Although details will be described later, skip rewards in accordance with the number of floors to be skipped are given to the player in the case in which the skip function is used. The skip rewards are the same types of rewards as the above-described stage rewards and a list of obtained skip rewards is displayed on the skip reward screen.

Then, when the close operation portion 40e provided on the skip reward screen is tapped, the skip reward screen becomes hidden and the game screen is displayed, as shown in FIG. 6D. Here, because 1^{st} to 15^{th} floors are skipped, the stage of a 16^{th} floor is displayed on the game screen. Accordingly, in the case in which the skip function is used, the dungeon quest in the normal play mode is started from the next floor from the skipped floors.

As has been described above, by using the skip function in the normal play mode, the player can play the dungeon quest from an intermediate floor. Therefore, the skip rewards include the weapons, the dragons, and the skills and the player can use the weapons, etc. obtained as the skip rewards in the subsequent dungeon quest.

In contrast, when the auto-play-mode selection operation portion 32c is tapped on the top screen shown in FIG. 3A, the auto play mode is set to a preparation state. The character selection screen is also displayed in this preparation state of the auto play mode and the player can select any one of the owned characters as the subject character. Then, when the subject character is selected on the character selection screen, an auto-play-mode setting screen is displayed.

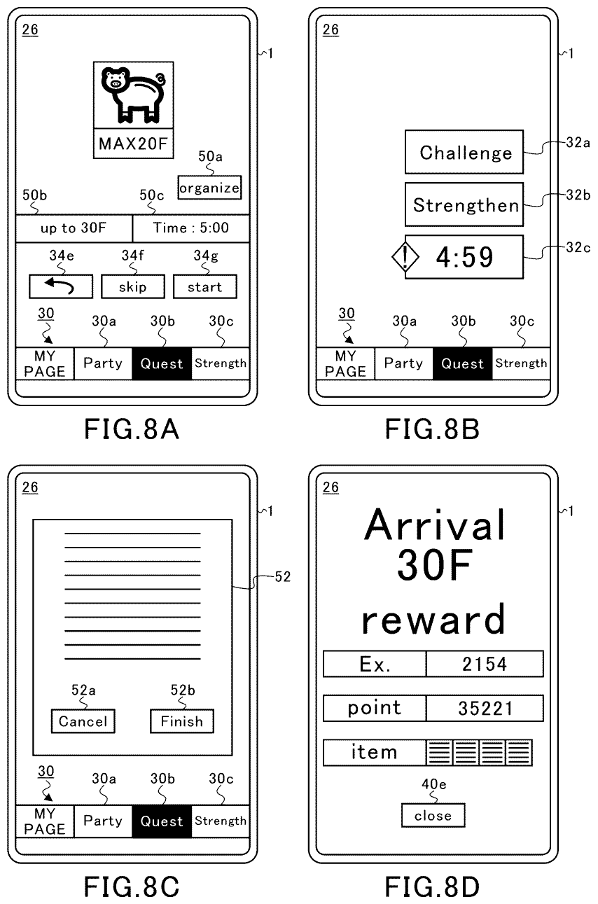

FIG. 8A is a diagram for explaining an example of the auto-play-mode setting screen. As shown in FIG. 8A, the auto-play-mode setting screen displays an image of a character the player selected as the subject character. In addition, on the auto-play-mode setting screen, similarly to the above description, the return operation portion 34e, the skip operation portion 34f, and the start operation portion 34g are provided, and, in addition, a formation operation portion 50a, a floor-to-be-reached display portion 50b, and an arrival-time display portion 50c are provided.

When the formation operation portion 50a is tapped, it is possible to change the subject character and enhance the owned characters. The floor-to-be-reached display portion 50b displays the highest floor the subject character can reach. As indicated above, the auto play mode is a play mode that does not require the player operation inputs and the game screen display and in which the game stages, in other words, the floor number, advance in association with passage of time. In more detail, in the auto play mode, the reached floor by the subject character is determined in accordance with the elapsed time from the start. Therefore, the auto play mode gives the player an impression of the subject character automatically advancing through the dungeon quest.

The highest floor that can be reached in the auto play mode is set in accordance with the highest floor reached by the player in the normal play mode. However, an upper limit to the highest floor that can be reached in the auto play mode is provided, and, here, the upper limit is set at the 30^{th} floor. Therefore, if the player has reached the 30^{th} floor or above in the normal play mode in the past, the subject character can reach up to the 30^{th} floor in the auto play mode.

Note that the highest floors that can be reached in the auto play mode is set every five floors. Therefore, for example, if the highest floor reached by the player is 5^{th} to 9^{th} floors, the highest floor that can be reached in the auto play mode is the 5^{th} floor and, if the highest floor reached by the player is 10^{th} to 14^{th} floors, the highest floor that can be reached in the auto play mode is the 10^{th} floor.

In addition, the type of the subject character does not affect the highest floor that can be reached in the auto play mode. For example, if the highest floor reached by the player is the 30^{th} floor, the highest floor that can be reached in the auto play mode is the 30^{th} floor regardless of the selected subject character. However, the highest floor that can be reached in the auto play mode may be set to each subject character. For example, the highest floor that can be reached may be set to be the 30^{th} floor for a subject character that has reached the 30^{th} floor in the past and the highest floor that can be reached may be set to be the 5^{th} floor for a subject character that has reached only up to the 8^{th} floor in the past.

Note that, here, an upper limit to the highest floor that can be reached in the auto play mode is provided; however, the upper limit is not essential. In addition, here, the highest floor that can be reached is set every five floors; however, the highest floor that can be reached in the auto play mode may completely match the highest floor reached by the player.

In addition, here, the player cannot select the highest floor that can be reached in the auto play mode. In other words, the highest floor that can be reached is automatically set on the basis of the highest floor that the player has reached in the past. However, the player may be allowed to arbitrarily set the floor that a subject character reaches in the auto play mode.

Also, the arrival-time display portion 50c displays the amount of time required for the subject character to reach the highest floor that can be reached. In the example shown in FIG. 8A, the floor-to-be-reached display portion 50b displays “30F” and the arrival-time display portion 50c displays “5 hours”. Therefore, in this case, it will take 5 hours for the subject character to reach the 30^{th} floor.

Although an illustration is omitted, the amount of time required to reach the respective floors in the auto play mode is set in advance. Specifically, it takes 30 min to reach the 5^{th} floor, it takes 1 hour to reach the 10^{th} floor, and, subsequently, 1 hour is added every 5 floors.

When the start operation portion 34g is tapped on the auto-play-mode setting screen, the dungeon quest in the auto play mode is started. Here, as a result of the dungeon quest being started, an elapsed time clock is started. While the elapsed time is being measured, it is considered that the dungeon quest in the auto play mode is being played.

FIG. 8B is a diagram for explaining an example of a top screen while the dungeon quest in the auto play mode is being played. FIG. 8C is a diagram for explaining an example of an interruption dialog 52. FIG. 8D is a diagram for explaining an example of an auto-play-mode result screen. While the dungeon quest in the auto play mode is being played, the remaining time is displayed in the auto-play-mode selection operation portion 32c on the top screen of the dungeon quest. The remaining time displayed in the auto-play-mode selection operation portion 32c is the amount of time remaining until the subject character reaches the highest floor that can be reached.

When the auto-play-mode selection operation portion 32c is tapped before the remaining time reaches 0, in other words, while the dungeon quest in the auto play mode is being played, the interruption dialog 52 shown in FIG. 8C is displayed. The player can interrupt and forcedly end the dungeon quest in the auto play mode. In the case in which the dungeon quest in the auto play mode is forcedly ended, the rewards in accordance with the elapsed time at that point in time are given to the player.

As indicated above, the amount of time required to reach the 5^{th} floor, the 10^{th} floor, the 15^{th} floor, the 20^{th} floor, the 25^{th} floor, and the 30^{th} floor are 30 min, 1 hour, 2 hours, 3 hours, 4 hours, and 5 hours, respectively. The rewards to be given to the player are determined with reference to these amounts of time required to reach the respective floors. Specifically, in the case in which the elapsed time at time of forced ending is less than 30 min, no reward is given to the player. In this case, the interruption dialog 52 displays a message indicating that no reward will be given to the player.

In addition, for example, in the case in which the elapsed time at time of forced ending is 30 min or more and less than 1 hour, the rewards corresponding to the 5^{th} floor are given to the player. In addition, for example, in the case in which the elapsed time at time of forced ending is 4 hours or more and less than 5 hours, the rewards corresponding to the 25^{th} floor are given to the player. Accordingly, the player can obtain reward even in the case in which the dungeon quest is forcedly ended and rewards that are advantageous to the player are given as the elapsed time increases.

A cancel operation portion 52a and an end operation portion 52b are provided in the interruption dialog 52. When the cancel operation portion 52a is tapped, the interruption dialog 52 is closed and the top screen shown in FIG. 8B is displayed. When the end operation portion 52b is tapped, the dungeon quest in the auto play mode is forcedly ended and an auto-play-mode result screen is displayed. In addition, in the case in which the auto-play-mode selection operation portion 32c is tapped in the state in which the remaining time is 0, in other words, the dungeon quest in the auto play mode is ended, the auto-play-mode result screen is also displayed.

As shown in FIG. 8D, the auto-play-mode result screen displays the reached floor and a list of the rewards. Note that the rewards for the dungeon quest in the auto play mode include the experience points, the points, and the special items and does not include the weapons, the skills, the dragons, etc. In other words, the rewards of the dungeon quest in the auto play mode are limited to the rewards that can be carried over to other games and the next and subsequent dungeon quests. When the close operation portion 40e provided on the result screen is tapped, the result screen becomes hidden and the top screen shown in FIG. 3A is displayed. Accordingly, it is possible to restart the dungeon quest in the auto play mode.

Note that, even while playing the dungeon quest in the auto play mode, the player can play the dungeon quest in the normal play mode. In other words, the player can simultaneously play the dungeon quest in the normal play mode and the dungeon quest in the auto play mode in parallel. However, it is not possible to use the same subject character in the two play modes being simultaneously played in parallel.

Specifically, when the normal-play-mode selection operation portion 32a is tapped while the dungeon quest in the auto play mode is being played, the character selection screen is displayed. At this time, the character selection screen is displayed in such a manner that the owned character selected as the subject character in the auto play mode cannot be selected as the subject character.

In addition, the player can also use the skip function in the auto play mode. When the skip operation portion 34f is tapped on the auto-play-mode setting screen shown in FIG. 8A, a number-of-floors-to-be-skipped selection screen for the auto play mode is displayed.

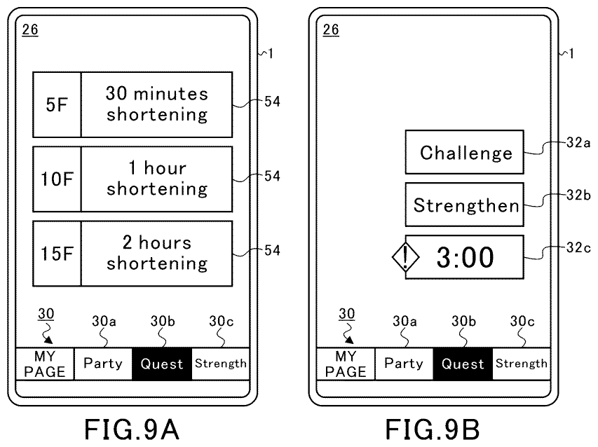

FIG. 9A is a diagram for explaining an example of the number-of-floors-to-be-skipped selection screen for the auto play mode. FIG. 9B is a diagram for explaining the remaining time when the skip function is used in the auto play mode. As shown in FIG. 9A, the number-of-floors-to-be-skipped selection screen for the auto play mode displays a number-of-floors-to-be-skipped selection operation portion 54. The number-of-floors-to-be-skipped selection operation portion 54 displays the number of floors that can be skipped. In the example shown in FIG. 9A, three number-of-floors-to-be-skipped selection operation portions 54 that respectively indicate 5F, 10F, and 15F are displayed. The number of floors that can be skipped are also set every five floors in the auto play mode and, as with the normal play mode, the player can set the number of floors to be skipped within the range defined by the highest floor reached by the selected subject character.

Here, the skip function in the auto play mode has an effect of reducing the remaining time. In other words, the amount of time required to reach the highest floor that can be reached is reduced in the case in which the skip function is used in the auto play mode. The amount of time reduced at this time is equal to the amount of time required to reach each floor. For example, if the 5^{th} floor, the 10^{th} floor, and the 15^{th} floor are skipped, the required amount of time is reduced by 30 min, 1 hour, and 2 hours, respectively. The number-of-floors-to-be-skipped selection operation portions 54 indicate the reductions in the required amounts of time in addition to the number of floors to be skipped.

When a number-of-floors-to-be-skipped selection operation portion 54 is tapped, the start operation portion 34g shown in FIG. 6B is displayed. Then, when the start operation portion 34g is tapped, the dungeon quest in the auto play mode employing the skip function is started. In this case, as shown in FIG. 9B, the auto-play-mode selection operation portion 32c displays the amount of the remaining time in which the amount of time corresponding to the number of skipped floors is subtracted from the amount of time required to reach the highest floor.

As has been described above, in the case in which the skip operation (tapping of the number-of-floors-to-be-skipped selection operation portion 42) is accepted in the normal play mode, the game is started from a prescribed floor by skipping the floors. In contrast, in the case in which the skip operation (tapping of the number-of-floors-to-be-skipped selection operation portion 54) is accepted in the auto play mode, the amount of time required to reach a prescribed floor is reduced. Accordingly, the skip function brings about different effects depending on the play mode in which said function is used.

Here, the types of the rewards determined in the auto play mode are the same as the types of the rewards determined in the normal play mode. Accordingly, there is a risk of reducing the motivation to play the dungeon quest in the normal play mode as a result of providing the auto play mode. To cope with this risk, the amounts of time required to reach the respective floors in the auto play mode are set to be greater than the amounts of time by which the same floors can be reached in the normal play mode.

For example, it takes 5 hours to reach the 30^{th} floor in the auto play mode. In contrast, the amount of time required to reach the 30^{th} floor is about 1 hour in the case in which the dungeon quest is played in the normal play mode. Note that this amount of time is the average amount of time of all players who have reached the 30^{th} floor and the shortest time for reaching the 30^{th} floor is even shorter. Accordingly, a relationship in which the amount of time required to reach a prescribed floor in the auto play mode is greater than the shortest time and the average amount of time for reaching the same floor in the normal play mode holds for all floors. Note that the amount of time required to reach a prescribed floor in the auto play mode may be greater than the presumed amount of time derived by means of a simulation based on various kinds of parameters set by developers or arrival times based on simulations performed by an AI.

As has been described above, because a greater amount of time is required to obtain the rewards in the auto play mode as compared with the normal play mode, the motivation to play the dungeon quest in the normal play mode is enhanced.

In addition, in this embodiment, the types of the rewards that can be obtained in the auto play mode are the same as the types of the rewards that can be obtained in the normal play mode. However, the acquisition of the rewards is set to be more advantageous to the player in the normal play mode than in the auto play mode.

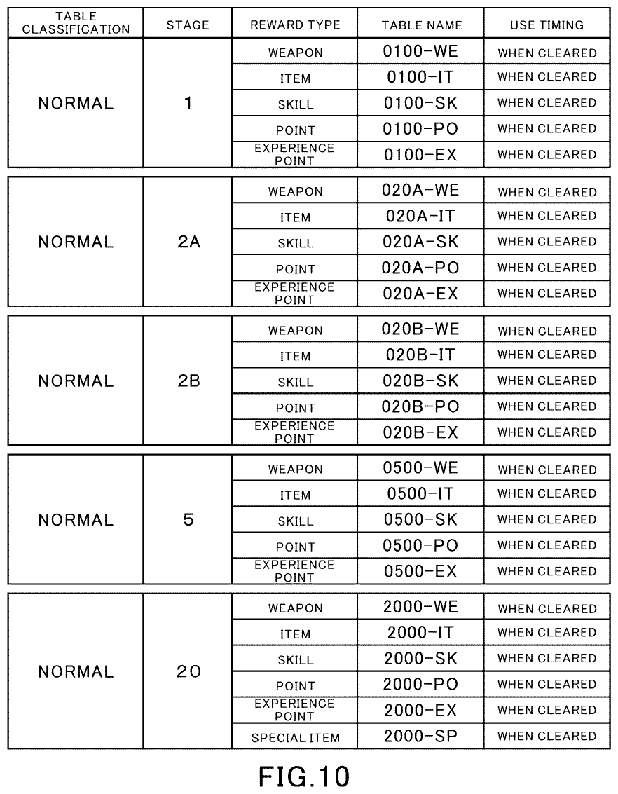

FIG. 10 is a diagram for explaining an example of normal reward tables. In this embodiment, the rewards to be given to the player are determined by means of lotteries employing reward tables. The reward tables are roughly divided into three table classifications, namely, normal reward tables, skip reward tables, and auto reward tables. The normal reward tables are reward tables that are employed in the case in which the dungeon quest is played in the normal play mode. The skip reward tables are reward tables that are employed in the case in which the skip function is used in the normal play mode. The auto reward tables are reward tables that are employed in the case in which the dungeon quest is played in the auto play mode.

As shown in FIG. 10, the normal reward tables are provided for each stage. Note that FIG. 10 indicates, as examples, normal reward tables for the stage 1, the stage 2A, the stage 2B, the stage 5, and the stage 20. In addition, normal reward tables for each stage are further classified in accordance with the reward types. FIG. 10 indicates the normal reward tables for the weapons, the items, the skills, the points, the experience points, and the special items.

With the normal reward table for the weapons, a weapon that can be used when playing the dungeon quest in the normal play mode is determined as a reward. With the normal reward table for the items, an item that can be used when playing the dungeon quest in the normal play mode is determined as a reward. With the normal reward table for the skills, a skill that can be used when playing the dungeon quest in the normal play mode is determined as a reward.

In addition, with the normal reward table for the points, points that can be used to enhance the owned characters, etc. are determined as rewards. With the normal reward table for the experience points, experience points with which the levels of the owned characters are increased are determined as rewards. With the normal reward table for special items, a special item that can be used in a normal quest that is different from the dungeon quest is determined as a reward. Note that the normal reward tables are not limited to the tables indicated in FIG. 10, for example, a normal reward table for the dragons for determining a dragon as a reward is provided.

When a stage is cleared in the normal play mode, the stage rewards are determined by employing the normal reward tables corresponding to the cleared stage. For example, when the stage 1 is cleared, lotteries for determining the stage rewards are performed by respectively employing the normal reward tables for the weapons, the items, the skills, the points, and the experience points. Note that the respective normal reward tables may be designed so that one of the rewards is always determined or may be designed so that, depending on the result of the lotteries, the reward is not determined, in other words, no reward is determined.

Accordingly, the lottery rates are designed so that the player wins stronger weapons, items, and skills with the normal reward tables of upper floors. In addition, the lottery rates are designed so that more experience points and points are obtained with the normal reward tables of upper floors.

Although the normal reward tables indicated in FIG. 10 are used when a stage is cleared, in-game reward tables (not shown) used while the dungeon quest is being played may be separately provided. For example, in the case in which treasure boxes are placed in the virtual game space, rewards to be given to the player are determined by means of the in-game reward tables when the treasure boxes are opened. In addition, rewards to be given to the player are also determined by employing the in-game reward tables when prescribed enemy characters are defeated.

Such rewards given via the lotteries employing the in-game reward tables are given to the player only in the case in which the dungeon quest is played in the normal play mode. Therefore, the player can obtain more rewards by playing the respective stages in the normal play mode as compared with the case in which the skip function is used and the case in which the game is played in the auto play mode.

In addition, in the normal play mode, five normal stages corresponding to each floor are provided on the second floor and above, as indicated above, and the normal stage to be set is determined by means of the stage lottery. Also, because the normal reward tables are different for each stage, the rewards the player obtains are also different depending on the result of the stage lottery.

In addition, in this embodiment, when the boss stages of the 20^{th} floor and above are cleared, the player can obtain special items. The principal purpose of the dungeon quest is to obtain the special items. A plurality of special items that can be obtained by clearing the boss stages of the 20^{th} floor and above are provided, and the winning rates for the special items with greater rarities increase as the floor number increases.

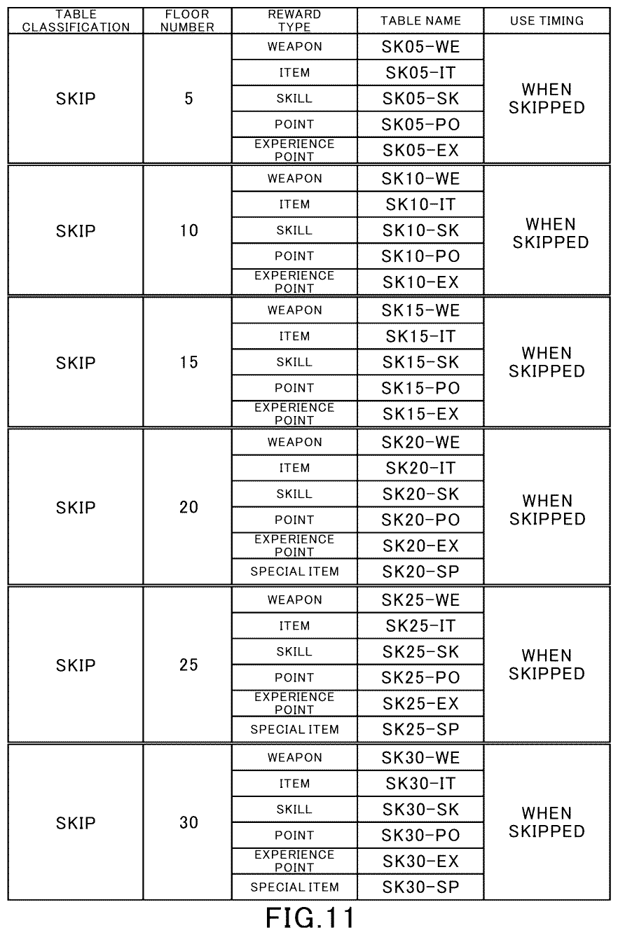

FIG. 11 is a diagram for explaining examples of skip reward tables. The skip reward tables are provided for each floor to be skipped. As indicated above, the player can select the number of floors to be skipped every five floors. Therefore, as indicated in FIG. 11, the skip reward tables are provided in six types, namely, tables for 5 floors, 10 floors, 15 floors, 20 floors, 25 floors, and 30 floors. In addition, the skip reward tables for each floor are further classified in accordance with the reward types. FIG. 11 indicates the skip reward tables for the weapons, the items, the skills, the points, the experience points, and the special items.

For example, in the case in which the number of floors to be skipped is 15, the lotteries for determining the rewards are performed by employing the skip reward tables for 15 floors. The reward lotteries employing the skip reward tables are performed when the floors are skipped. The lottery rates are designed so that the player wins stronger weapons, items, and skills with the skip reward tables associated with a greater number of floors to be skipped. As indicated above, in the case in which the skip function is used in the normal play mode, the player needs to play the game from a stage on the next floor by skipping the floors in accordance with the number of floors to be skipped. Because stronger weapons, etc. can be obtained as the number of floors to be skipped increases, it is possible to avoid a situation in which it becomes considerably difficult to clear subsequent stages in the case in which the skip function is used.

In addition, the lottery rates are designed so that greater experience points and points can be obtained with the skip reward tables associated with a greater number of floors to be skipped. In addition, as with the above-described normal reward tables, the skip reward tables for the special items are employed only in the case in which the number of floors to be skipped is equal to or greater than 20. In addition, the lottery rates are designed so that the winning rates for the special items with greater rarities increase as the number of floors to be skipped increases.

In the case in which the skip function is used, the rewards are given to the player, first, by means of the lotteries employing the skip reward tables. Subsequently, the player plays the respective stages in the normal play mode from the next floor after the skipped floors. In this case, each time a stage is cleared, additional rewards are given to the player as a result of the lotteries employing the normal reward tables for the cleared stage.

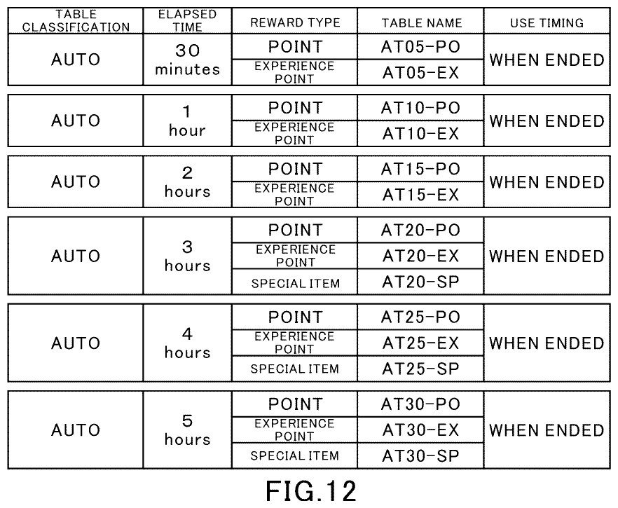

FIG. 12 is a diagram for explaining examples of auto reward tables. The auto reward tables are provided for the respective elapsed times. As indicated above, in the auto play mode, the elapsed times are associated with the reached floors, and the auto reward tables are provided for the respective reached floors. As indicated in FIG. 12, the auto reward tables are provided in six types, namely, tables for 30 min, 1 hour, 2 hours, 3 hours, 4 hours, and 5 hours. In addition, the auto reward tables for each elapsed time are further classified in accordance with the reward types. FIG. 12 indicates the auto reward tables for the points, the experience points, and the special items.

When the player ends the dungeon quest in the auto play mode, the rewards are determined by means of the lotteries employing the auto reward tables corresponding to the elapsed time at that point in time. For example, in the case in which the elapsed time is equal to and greater than 3 hours and less than 4 hours, the lotteries are performed by employing the auto reward tables for 3 hours. Therefore, in this case, the points, the experience points, and the special items could be determined to be the rewards.

Note that, in the auto play mode, the special items could be determined as the rewards in the case in which the elapsed time is 3 hours or more. As indicated above, it takes 3 hours to reach the 20^{th} floor in the auto play mode. Therefore, the player can also obtain the special items in the auto play mode by reaching 20^{th} floor or higher.

Here, as indicated above, the skip function can also be used in the auto play mode. However, even if the skip function is used in the auto play mode, the lotteries employing the skip reward tables are not performed. In other words, in the auto play mode, using the skip function only reduces the remaining time until reaching a prescribed floor and the skip rewards are not given. Therefore, in the auto play mode, only the rewards corresponding to the elapsed times are given to the player. However, the skip rewards may be given to the player in the case in which the skip function is used in the auto play mode.

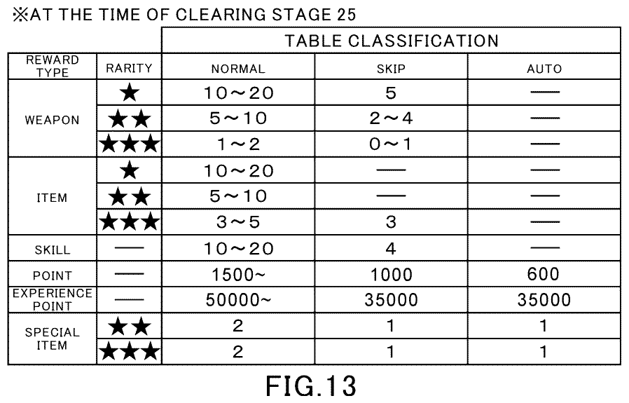

FIG. 13 is a diagram for explaining an example of the breakdown of the rewards for the respective table classification. FIG. 13 indicates examples of the rewards the player has obtained before the point in time at which the stage of the 25^{th} floor is cleared. For example, in the case in which the game is played in the normal play mode from the 1^{st} floor without using the skip function, at the point in time at which the stage of the 25^{th} floor is cleared, the player can obtain 10-20 one-star weapons, 5-10 two-star weapons, and 1-2 three-star weapons. Note that, in FIG. 13, the number of stars of the weapon, the items, etc. indicates the rarity, specifically, the rarity increase as the number of stars increases. The weapons and the items with greater rarities make it possible to advance through the quest in an advantageous manner.

In addition, in the case in which the game is played in the normal play mode from the 1^{st} floor, at the point in time at which the stage of the 25^{th} floor is cleared, the player can obtain 10-20 one-star items, 5-10 two-star items, and 3-5 three-star items. In addition, in this case, the player can obtain 10-20 skills, 1500 or greater points, and 50000 or greater experience points and, furthermore, the player can obtain 2 two-star special items and 2 three-star special items.

In contrast, in the case in which the skip function is used by setting the number of floors to be skipped to 25, the skip rewards are determined by means of the lotteries employing the skip reward tables associated with the number of floors to be skipped of 25. With these tables, the player can obtain 5 one-star weapons, 2-4 two-star weapons, 0-1 three-star weapons, 3 three-star items, 4 skills, 1000 points, 35000 experience points, 1 two-star special item, and 1 three-star special item.

In addition, in the case in which the reached floor is the 25^{th} floor when the auto play mode is ended, the rewards are determined by means of the lotteries employing the auto reward tables for the elapsed time of 4 hours. With these tables, the player can obtain 600 point, 35000 experience points, 1 two-star special item, and 1 three-star special item.

As has been described above, the reward conditions (the number and the contents of the rewards to be given to the player) in the normal play mode are set to be more advantageous than the reward conditions in the auto play mode. Accordingly, the player is motivated to play the game in the normal play mode, and thus, the game motivation can be enhanced. In addition, in the normal play mode, the reward conditions are more advantageous in the case in which the skip function is not used than in the case in which the skip function is used. Therefore, even if the number of times the skip function can be used is limited, the player is motivated to play the game without using the skip function, and thus, the game motivation can be enhanced.

In the following, the functional configuration of the information processing system S will be described, and, among processing executed by individual functional units, functional units and processing related to the dungeon quest will mainly be described.

### (Functional Configuration of Information Processing System S)

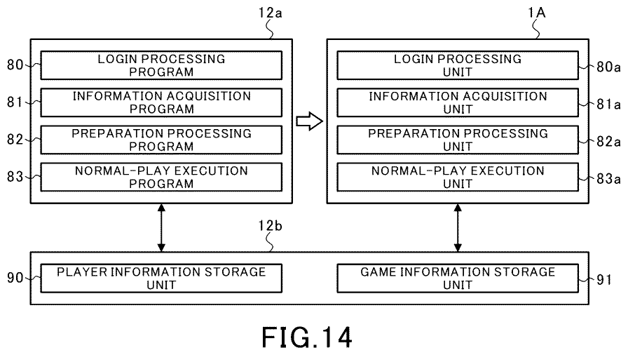

FIG. 14 is a diagram for explaining the configuration of the memory 12 in the player terminal 1 and functions as a computer. The memory 12 of the player terminal 1 is provided with a program storage area 12a and a data storage area 12b. The CPU 10 stores, when the game is started, various kinds of programs (modules) in the program storage area 12a. The programs stored in the program storage area 12a include a login processing program 80, an information acquisition program 81, a preparation processing program 82, and a normal-play execution program 83. Note that the programs indicated in FIG. 14 are examples, and numerous other programs are provided as the programs to be stored in the program storage area 12a.

The data storage area 12b is provided with a player information storage unit 90 and a game information storage unit 91 as storage units that store data. Note that the respective storage units, described above, are examples, and the data storage area 12b is provided with numerous other storage units.

The CPU 10 runs the respective programs stored in the program storage area 12a and updates data in the respective storage units in the data storage area 12b. Thus, the CPU 10 causes the player terminal 1 to function as a game control unit 1A by running the respective programs stored in the program storage area 12a.

The game control unit 1A includes a login processing unit 80a, an information acquisition unit 81a, a preparation processing unit 82a, and a normal-play execution unit 83a. Specifically, the CPU 10 runs the login processing program 80 and causes the computer to function as the login processing unit 80a. Similarly, the CPU 10 runs the information acquisition program 81, the preparation processing program 82, and the normal-play execution program 83 and causes the computer to function as the information acquisition unit 81a, the preparation processing unit 82a, and the normal-play execution unit 83a, respectively.

When the player inputs a login operation to the player terminal 1, the login processing unit 80a transmits the login information to the server 100.

The information acquisition unit 81a downloads various kinds of information set in the server 100 and stores said information in the player information storage unit 90 and the game information storage unit 91 in the data storage area 12b.

The preparation processing unit 82a executes processing in the preparation state of the dungeon quest.

The normal-play execution unit 83a executes processing for executing the dungeon quest in the normal play mode.

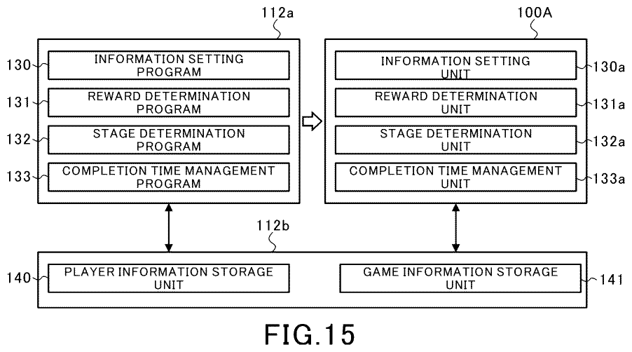

FIG. 15 is a diagram for explaining the configuration of the memory 112 in the server 100 and the functions as a computer. The memory 112 in the server 100 is provided with a program storage area 112a and a data storage area 112b. The CPU 110 stores various kinds of programs (modules) in the program storage area 112a. The programs to be stored in the program storage area 112a include an information setting program 130, a reward determination program 131, a stage determination program 132, and a completion time management program 133. Note that the programs indicated in FIG. 15 are examples, and numerous other programs are provided as the programs to be stored in the program storage area 112a.

The data storage area 112b is provided with a player information storage unit 140 and a game information storage unit 141 as storage units that store data. Note that the respective storage units, described above, are examples, and the data storage area 112b is provided with numerous other storage units.

The CPU 110 runs the respective programs stored in the program storage area 112a and updates data in the respective storage units in the data storage area 112b. Thus, the CPU 110 causes the server 100 to function as a game control unit 100A by running the respective programs stored in the program storage area 112a.

The game control unit 100A includes an information setting unit 130a, a reward determination unit 131a, a stage determination unit 132a, and a completion time management unit 133a. Specifically, the CPU 110 runs the information setting program 130 and causes the computer to function as the information setting unit 130a. Similarly, the CPU 110 runs the reward determination program 131, the stage determination program 132, and the completion time management program 133 and causes the computer to function as the reward determination unit 131a, the stage determination unit 132a, and the completion time management unit 133a, respectively.

The information setting unit 130a sets the information to be downloaded to the player terminal 1 on the basis of the information received from the player terminal 1. In addition, the information setting unit 130a updates various kinds of information in the player information storage unit 140 and the game information storage unit 141.

The reward determination unit 131a determines the rewards to be given to the player in the dungeon quest.

The stage determination unit 132a determines the stage the player plays in the dungeon quest in the normal play mode.

The completion time management unit 133a manages, in the dungeon quest in the auto play mode, the amount of time until reaching the highest floor that can be reached, in other words, a completion time until the auto play mode is completed.

Next, an example of the processing performed by the information processing system S will be described.

### (Processing Performed by Information Processing System S)

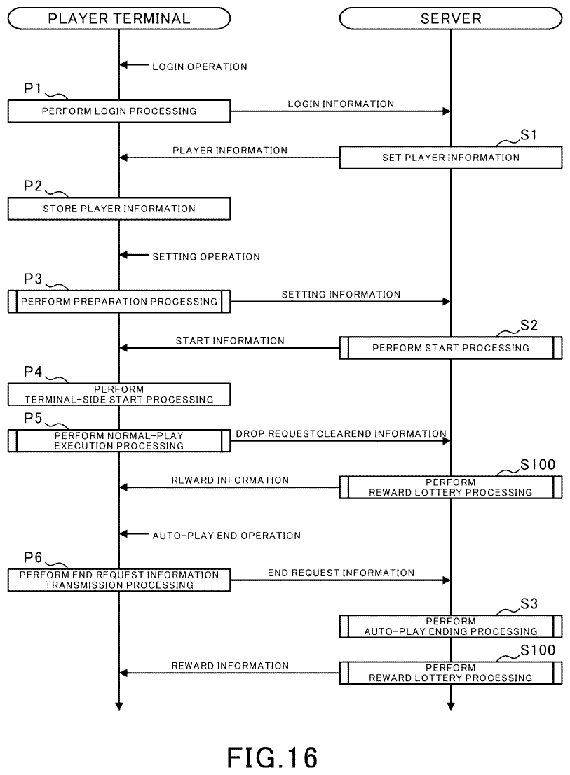

FIG. 16 is a sequence diagram for explaining basic processing performed in the player terminal 1 and the server 100. When the login operation is input to the player terminal 1, the login processing unit 80a in the player terminal 1 transmits the login information to the server 100 (P1). When the login information is received, the information setting unit 130a in the server 100 sets various kinds of player information stored in association with the player ID (S1). When the player information is received from the server 100, the information acquisition unit 81a of the player terminal 1 stores the player information in the player information storage unit 90 (P2).

In addition, in the player terminal 1, when setting operations for performing various kinds of settings related to the dungeon quest are input from the top screen (see FIG. 3A) of the dungeon quest, the preparation processing unit 82a executes preparation processing (P3).

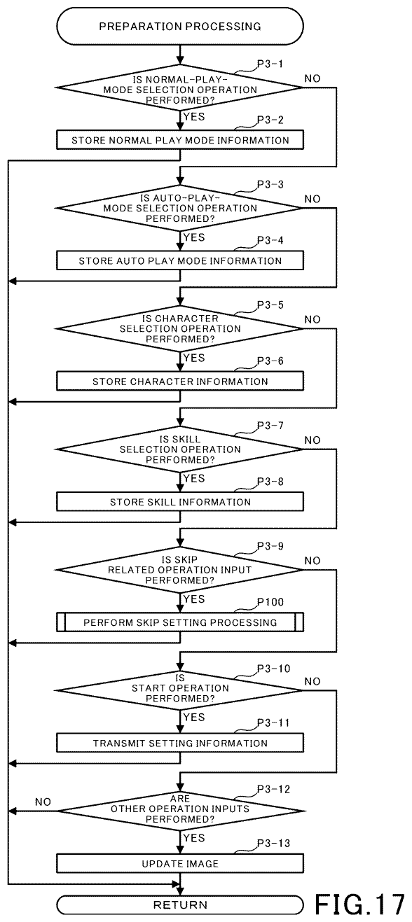

FIG. 17 is a flowchart for explaining the preparation processing (P3) performed in the player terminal 1. When the normal-play-mode selection operation is input (the normal-play-mode selection operation portion 32a in FIG. 3A is tapped) on the top screen (“YES” in P3-1), the preparation processing unit 82a stores normal play mode information indicating that the normal play mode is selected in the game information storage unit 91 (P3-2).

In addition, when the auto-play-mode selection operation is input (the auto-play-mode selection operation portion 32c in FIG. 3A is tapped) on the top screen (“YES” in P3-3), the preparation processing unit 82a stores auto play mode information indicating that the auto play mode is selected in the game information storage unit 91 (P3-4).

In addition, when the character selection operation is input (the character icon 34a in FIG. 3B is tapped) on the character selection screen (“YES” in P3-5), the preparation processing unit 82a stores character information indicating the selected character in the game information storage unit 91 (P3-6).

In addition, when the skill selection operation is input (the skill icon 34d in FIG. 3C is tapped) on the skill selection screen (“YES” in P3-7), the preparation processing unit 82a stores skill information indicating the selected skill in the game information storage unit 91 (P3-8).

In addition, the skip related operation is input (the skip operation portion 34f in FIGS. 3B, 3C, and 8A, the number-of-floors-to-be-skipped selection operation portion 42 in FIG. 6A, or the number-of-floors-to-be-skipped selection operation portion 54 in FIG. 9A is tapped) (“YES” in P3-9), the preparation processing unit 82a executes skip setting processing (P100).

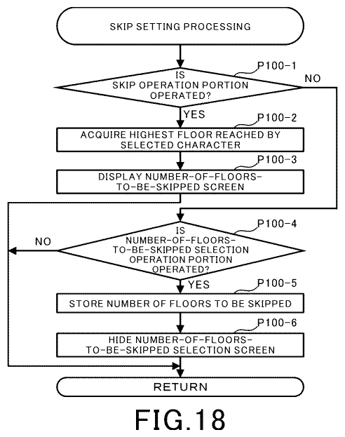

FIG. 18 is a flowchart for explaining the skip setting processing (P100) performed in the player terminal 1. When the skip operation portion 34f is operated (“YES” in P100-1), the preparation processing unit 82a acquires the highest floor reached by the selected character stored in the game information storage unit 91 (P100-2) and displays the number-of-floors-to-be-skipped selection screen indicated in FIG. 6A or 9A (P100-3).

In addition, when the number-of-floors-to-be-skipped selection operation portion 42 or 54 is operated (“YES” in P100-4), the preparation processing unit 82a stores the selected number of floors to be skipped in the game information storage unit 91 (P100-5) and hides the number-of-floors-to-be-skipped selection screen indicated in FIG. 6A or 9A (P100-6).

Returning to FIG. 17, when the start operation is input (start operation portion 34g in FIGS. 3B, 3C, 6B, and 8A is tapped) (“YES” in P3-10), the preparation processing unit 82a transmits setting information set by the player to the server 100 (P3-11). Note that the setting information includes information indicating the play mode, the character, the skills, and the number of floors to be skipped selected by the player.

In addition, in the preparation state, when other operations are input (for example, the enhancement operation portion 32b, the character tab 34b, the skill tab 34c, the return operation portion 34e, the formation operation portion 50a, the cancel operation portion 52a, or the end operation portion 52b is tapped) (“YES” in P3-12), the preparation processing unit 82a updates the screen on the display 26 (P3-13).

Returning to FIG. 16, when the setting information is transmitted to the server 100 from the player terminal 1, start processing (S2) is executed in the server 100.

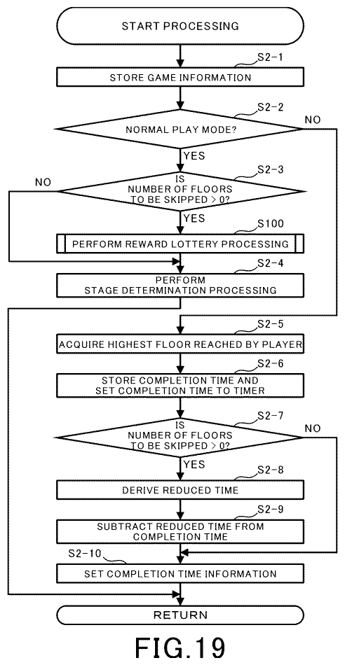

FIG. 19 is a flowchart for explaining the start processing performed in the server 100. The information setting unit 130a stores the game information, such as the play mode, the character, the skills, the number of floors to be skipped, etc. selected by the player, in the game information storage unit 141 on the basis of the received setting information (S2-1).

Also, in the case in which the normal play mode is selected as the play mode (“YES” in S2-2) and the number of floors to be skipped is set (“YES” in S2-3), the reward determination unit 131a executes reward lottery processing (S100).

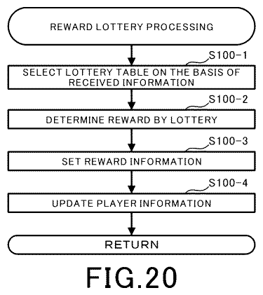

FIG. 20 is a flowchart for explaining the reward lottery processing (S100) performed in the server 100. The reward determination unit 131a selects the lottery tables to be employed when determining the rewards on the basis of the received information received from the player terminal 1 (S100-1). Then, the reward determination unit 131a determines the rewards to be given to the player by means of the lotteries employing the selected lottery tables (S100-2). The information setting unit 130a sets reward information indicating the determined rewards and transmits said information to the player terminal 1 (S100-3). In addition, the information setting unit 130a updates the player information storage unit 140 and gives the determined rewards to the player (S100-4).

Returning to FIG. 19, in the case in which the normal play mode is selected (“YES” in S2-2), the stage determination unit 132a executes stage determination processing (S2-4). Here, the stage determination unit 132a determines and stores all stages that could be played by the player. For example, in the case in which the number of floors to be skipped is 0, the stages to be played by the player are determined for all of the 1^{st} to 50^{th} floors. In addition, for example, in the case in which the number of floors to be skipped is 15, the stages for the 16^{th} to 50^{th} floors are determined. When the stages are determined, the information setting unit 130a sets stage information indicating the stages and transmits said information to the player terminal 1.

Note that, in this embodiment, all stages to be played by the player are determined when the dungeon quest in the normal play mode is started. However, the reward determination unit 131a may determine only the next stage each time one stage is cleared.

In addition, although stages are not determined for the skipped floors here, the stages may also be determined for the skipped floors. As indicated above, in the case in which the floors are skipped, the skip rewards in accordance with the number of skipped floors are given to the player and the stage rewards corresponding to the skipped floors are not given to the player. However, the stage rewards corresponding to the skipped floors may be given to the player. In this case, the stages are also determined for the floors to be skipped and the rewards are determined by employing the normal reward tables for the determined stages.

In addition, although the stages are not determined in the case in which the auto play mode is selected here, the stages may be determined also in the case in which the auto play mode is selected. As indicated above, in the auto play mode, the rewards in accordance with the elapsed time are given to the player and the stage rewards are not given to the player. However, in the auto play mode also, the stage rewards may be given to the player. In this case, the stage for each floor is determined and the rewards are determined by employing the normal reward tables for the determined stage.

In the case in which the auto play mode is selected (“NO” in S2-2), the completion time management unit 133a acquires the highest floor reached by the player (S2-5). Also, the completion time management unit 133a derives, from the acquired highest floor reached, the highest floor that can be reached in the current round of the dungeon quest and the completion time and stores said information in the game information storage unit 141 (S2-6). In addition, here, the completion time management unit 133a sets the completion time in the timer.

In addition, in the case in which the number of floors to be skipped is set (“YES” in S2-7), the completion time management unit 133a derives the reduction time (S2-8). Here, the reduction time is derived in accordance with the number of floors to be skipped. The completion time management unit 133a subtracts the reduction time from the completion time stored in the game information storage unit 141 and the completion time set in the timer (S2-9). The information setting unit 130a sets completion time information indicating the completion time and transmits said information to the player terminal 1 (S2-10).

Returning to FIG. 16, when the player terminal 1 receives the start information (the reward information, the stage information, and the completion time information) from the server 100, the game control unit 1A executes terminal-side start processing (P4). Here, the information acquisition unit 81a updates information in the player information storage unit 90 and the game information storage unit 91 on the basis of the received start information. In addition, when the game is started in the auto play mode, the auto-play-mode selection operation portion 32c displays the completion time, as indicated in FIG. 8B. In the case in which the game is started in the normal play mode and the skip function is used, the skip reward screen is displayed, as indicated in FIG. 6C. In the case in which the game is started in the normal play mode and the skip function is not used, the game screen is displayed, as indicated in FIG. 4A, and normal-play execution processing (P5) is started.

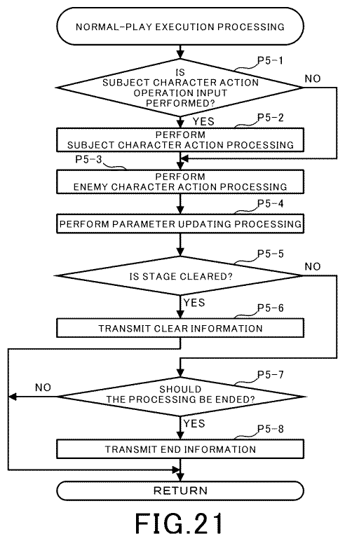

FIG. 21 is a flowchart for explaining the normal-play execution processing (P5) performed in the player terminal 1. When action operations for the subject character are input (“YES” in P5-1), the normal-play execution unit 83a executes action processing for causing the subject character to perform actions (P5-2). The action operations include, for example, movement operations to cause the subject character to move, offensive operations to execute normal attacks, skill operations to activate the skills, etc. In the action processing, processing corresponding to the input action operations is executed.

In addition, the normal-play execution unit 83a executes enemy-character action processing for determining and executing enemy character actions (P5-3). In addition, the normal-play execution unit 83a executes parameter updating processing for updating the various kinds of parameters in association with the actions of the subject character and the enemy characters (P5-4).

In addition, when the conditions for clearing a stage are met and the stage is cleared (“YES” in P5-5), the normal-play execution unit 83a transmits clear information to the server 100 (P5-6). In addition, when end conditions, such as the player HP becoming 0, are met (“YES” in P5-7), the normal-play execution unit 83a transmits end information to the server 100 (P5-8).

Returning to FIG. 16, during the normal-play execution processing performed in the player terminal 1, the clear information and the end information, described above, and, additionally, drop request information for when the treasure boxes are opened and the enemy characters are defeated is transmitted to the server 100 from the player terminal 1. When said information is received, the above-described reward lottery processing is executed in the server 100 (S100). The player terminal 1 receives the reward information from the server 100 and updates the information in the player information storage unit 90 or the game information storage unit 91.

In addition, as indicated above, when the dungeon quest in the auto play mode is being played, the auto-play-mode selection operation portion 32c displays the remaining time. In this state, when an auto-play end operation for ending the dungeon quest in the auto play mode is input (the end operation portion 52b in the interruption dialog 52 in FIG. 8C is tapped), the game control unit 1A transmits end request information to the server 100 (P6). When the end request information is received, auto-play ending processing (S3) is executed in the server 100.

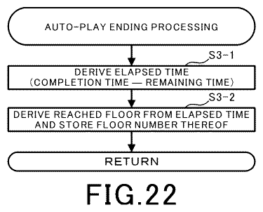

FIG. 22 is a flowchart for explaining the auto-play ending processing (S3) performed in the server 100. The completion time management unit 133a derives the elapsed time by subtracting the remaining time from the completion time (S3-1). In addition, the completion time management unit 133a derives the reached floor from the elapsed time and stores the reached floor in the player information storage unit 140 (S3-2).

Returning to FIG. 16, when the auto-play ending processing is executed, the reward determination unit 131a executes the above-described reward lottery processing (S100). Here, the rewards are determined by means of the lotteries employing auto lottery tables corresponding to the elapsed time. Accordingly, the player terminal 1 receives reward information and the player terminal 1 displays the result screen indicated in FIG. 8D.

As above, an aspect of the embodiment has been described with reference to the attached drawings; however, it is needless to mention that the present invention is naturally not limited to the above-described embodiment. It is obvious to a person skilled in the art that various kinds of modifications or revised examples are conceivable within the scope of what is recited in the claims and such forms are also understood to belong to the technical scope as a matter of course.

In the above-described embodiment, the division of the processing performed in the player terminal 1 and the server 100 is merely an example. For example, each of the above-described processing may be executed in at least one of the player terminal 1 and the server 100, the execution timing thereof and devices that execute said processing are not particularly limited. In the above-described embodiment, the reward lotteries are executed in the server 100; however, the reward lotteries may be executed in the player terminal 1.

Although the above-described embodiment has been described in terms of the case in which the game genre is action RPG, the game genre is not particularly limited. In any case, in the case in which a game is started in the first play mode in which game stages proceed on the basis of player operations input while a game screen is being displayed, rewards may be determined on the basis of the reached game stage; in the case in which the game is started in the second play mode in which player operation inputs and game screen display are not required and the game stages proceed with the passage of time, the rewards may be determined on the basis of the elapsed time or the reached game stage; and the determined rewards may be given to the player. Therefore, so long as a plurality of game stages are provided, the above-described technical matters may be applied to action games, puzzle games, rhythm games, and RPGs.

Although the floors are provided as the game stages in the above-described embodiment, the game stages are not limited thereto. In the above-described embodiment, the game stages are the floors, in other words, the stages, and the player can proceed to the next game stage by clearing each game stage. In other words, in the above-described embodiment, the individual game stages are clearly distinguished. However, the game stages do not necessarily need to be clearly distinguished. For example, in a game in which save points are provided in a virtual game space, the save points may be regarded as game stages. In addition, for example, progress rates before clearing a single stage may be regarded as game stages.

In addition, the rewards in the above-described embodiment are mere examples. In the above-described embodiment, the types of the rewards determined in the auto play mode (second play mode) are the same as the types of the rewards determined in the normal play mode (first play mode). Examples of the types of the rewards that are the same between the two play modes include the points, the experience points, and the special items. In addition, in the above-described embodiment, a plurality of rewards with different rarities are provided in one type of reward. However, only one reward may be provided as one type of reward.

In addition, in the above-described embodiment, it is assumed that the relationship in which the amount of time required to reach a prescribed floor in the auto play mode is greater than the shortest time and the average time for reaching the same floor in the normal play mode holds in all floors. However, the above-described relationship may be held in some of floors, for example, in the case in which the floor number is equal to or greater than a prescribed number.

Alternatively, in the case in which a time limit is provided in each floor or each stage, the amount of time required to reach a prescribed floor in the auto play mode (second play mode) may be set to be greater than the longest time for reaching the same floor in the normal play mode (first play mode), in other words, the amount of time corresponding to the sum of all time limits.

In addition, the above-described embodiment has been described in terms of the case in which the skip function can be used in both the normal play mode and the auto play mode. However, the skip function may be usable only in one of the normal play mode and the auto play mode or the skip function may be omitted.

Note that the information processing programs for executing the processing in the above-described embodiment may be stored in a computer-readable non-transitory storage medium and may be provided in the form of the storage medium. Furthermore, a game terminal device containing this storage medium may be provided. In addition, the above-described embodiment may take the form of an information processing method for realizing the respective functions and steps indicated in the flowcharts.

What is claimed is:

1. A non-transitory computer readable medium storing a program causing a computer to execute:
processing for determining a reward on the basis of a reached game stage when a game is started in a first play mode in which game stages proceed on the basis of an operation input by a player while a game screen is displayed;
processing for determining a reward on the basis of an elapsed time or a reached game stage when the game is started in a second play mode in which the player operation input and the game screen display are not required and the game stages proceed in association with the passage of time; and
processing for giving the determined reward to the player, wherein
the type of the reward determined in the second play mode is the same as the type of the reward determined in the first play mode and,
in the second play mode, the amount of time required to reach a first game stage is greater than the shortest time by which the first game stage can be reached in the first play mode.

2. The non-transitory computer readable medium according to claim 1, wherein the program further causes the computer to execute:
processing for advancing the game on the basis of the operation input by the player in the case in which the game is started in the first play mode; and
processing for receiving a skip operation input by the player in the first play mode, wherein,
in the case in which the skip operation is received in the first play mode, the processing for advancing the game on the basis of the operation input by the player skips one or more game stages and the game is started from a second game stage.

3. The non-transitory computer readable medium according to claim 1, wherein the program further causes the computer to execute:
processing for receiving a skip operation input by the player in the second play mode, wherein,
in the case in which the skip operation is received in the second play mode, the amount of time required to reach a prescribed game stage is reduced.

4. An information processing method executed by a computer, the information processing method comprising:
processing for determining a reward on the basis of a reached game stage when a game is started in a first play mode in which game stages proceed on the basis of an operation input by a player while a game screen is displayed;
processing for determining a reward on the basis of an elapsed time or a reached game stage when the game is started in a second play mode in which the player operation input and the game screen display are not required and the game stages proceed in association with the passage of time; and
processing for giving the determined reward to the player, wherein
the type of the reward determined in the first play mode is the same as the type of the reward determined in the second play mode and,
in the second play mode, the amount of time required to reach a first game stage is greater than the shortest time by which the first game stage can be reached in the first play mode.

5. An information processing system in which a computer executes:
processing for determining a reward on the basis of a reached game stage when a game is started in a first play mode in which game stages proceed on the basis of an operation input by a player while a game screen is displayed;
processing for determining a reward on the basis of an elapsed time or a reached game stage when the game is started in a second play mode in which the player operation input and the game screen display are not required and the game stages proceed in association with the passage of time; and
processing for giving the determined reward to the player, wherein
the type of the reward determined in the first play mode is the same as the type of the reward determined in the second play mode and,
in the second play mode, the amount of time required to reach a first game stage is greater than the shortest time by which the first game stage can be reached in the first play mode.
